(19) United States
(12) Patent Application Publication
(10) Pub. No.: US 2005/0137867 A1
(43) Pub. Date: Jun. 23, 2005

(54) Method for electronically generating a synchronized textual transcript of an audio recording

(76) Inventor: Mark R. Miller, La Jolla, CA (US)

Correspondence Address: CHARMASSON & BUCHACA & LEACH LLP, 1545 HOTEL CIRCLE SOUTH, SUITE 150, SAN DIEGO, CA, 92108-3412, US

(21) Appl. No.: 10/740,883

(22) Filed: Dec. 17, 2003

(51) Int. Cl. G10L 15/00

(52) U.S. Cl. 704/252

(57) ABSTRACT

A process for producing a recorded version of proceedings that is aligned with a textual transcription of the same proceedings. The process using an audio recording of the proceedings matches words recognized by a speech-recognition program with words in the textual transcription file. Each word of the textual transcription, is marked with the time at which the corresponding word occurred in the recording. The transcribed recording and transcription file are sent in a series of sequences from one or more user stations. The server distributes the word matching and word timing tasks to one of a number of workstations before returning the time marked transcription file to the user stations. The process is particularly useful in preparing and presenting recordings of witness' depositions and other legal proceedings.

### FIELD OF THE INVENTION

This invention relates to forensic and archival transcripts from recordings of various types of proceedings, and in particular, audio or audio-visual witness depositions and other legal proceedings, and to the synchronization of the textual and audio-visual material such as the close captioning of video programs for the hearing impaired.

### BACKGROUND OF THE INVENTION

All depositions of witnesses and other pretrial proceedings are often recorded on audio or audio-visual media so that they can be played back in court. These proceedings are, in almost all cases, simulataneously transcribed by a stenographic court reporter into a textual file.

Many times, due to the lack of clarity of the audio recording, or the poor enunciation of the witness, spoken words are not easily understandable when the recording is played back. The parties must resort to the transcribed text to clarify the wording. It can take several minutes of court time to locate a particular portion of the proceedings being played to the judge and jury by thumbing through the official transcript.

This invention came about while attempting to find a solution to the phonetically unreliability of audio and audio-visual recordings of legal proceedings, and a convenient method for providing close captioning of video sequences for the hearing impaired.

### SUMMARY OF THE INVENTION

The principal and secondary objects of this invention are to greatly improve the comprehension of audio and audio-visual recordings of legal proceedings, to provide an textual display of the official transcript of these proceedings in synchronization with the audio or audio-visual display on the same screen, and to perform these tasks by means of a network system accessible by a number of customers working with the same forensic material, whereby accurate and aligned textual transcription of the audio recording and the proceeding transcription files can be readily accessed at any time by the judge and the lawyers from both parties to the litigation.

These and other valuable objects are achieved by means of a data processing system wherein audio recordings or the audio portion stripped from an audio-visual recording of separate sequences of a deposition or other legal proceedings and the textual transcript of the same proceedings are sent to a server in encrypted and compressed formats. The server distributes the audio and transcription file to a number of workstations.

The workstations join the various audio sequences in a continuous program after removing any redundant head or tail sections of these sequences.

The workstation then matches the words of the audio file with the corresponding work in the transcription file using a speech recognition program. Each word in the transcripted file is then time-marked with the time the corresponding word occurred in the audio file. The timed textual file is then transferred to the server and made accessible by the customers' computers.

### BRIEF DESCRIPTION OF THE DRAWING

FIG. 1 is a block diagram of the hardware system used in the transcription and alignment process;

FIG. 2 is a flow diagram of the transcription and alignment process; and

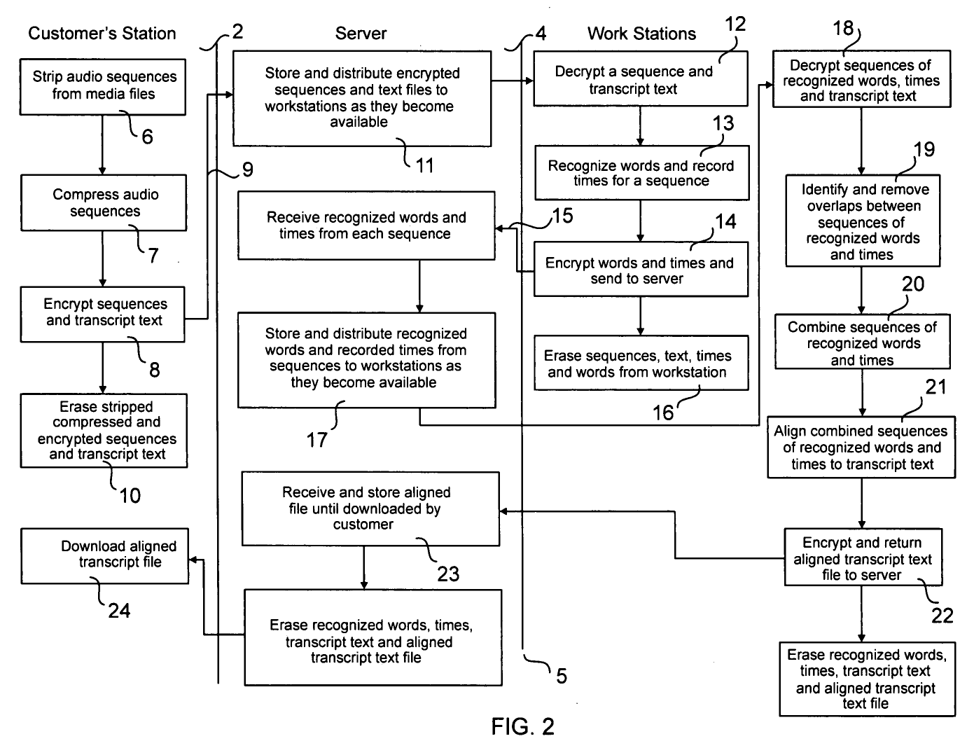

FIG. 3 is a flow-chart of the overlap detection and suppression program.

### DESCRIPTION OF THE PREFERRED EMBODIMENT OF THE INVENTION

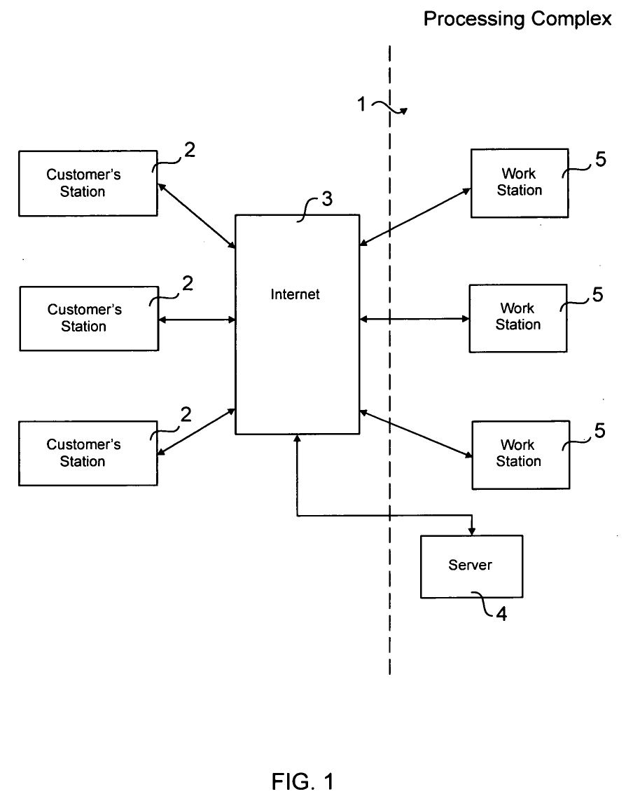

Referring now to the drawing, there is shown in FIG. 1, a block diagram of the basic system architecture for practicing the invention. A processing complex 1 is accessible to a number of customers' computer stations 2 via the Internet 3. The processing complex comprises a server 4 and a number of workstations 5 also linked through the Internet 3 to the server.

At the beginning of the process, at least one of the customer's stations holds a digital audio or audio/video file of a witness deposition or other proceedings as well as a transcribed textual file of the same proceedings. Typically, the transcribed textual file is generated by a stenographic court reporter. In the case of a audio-video file, the video portion is first separated 6 from the audio portion, the stripped audio portion is retained for the below-described processing. The audio recording usually consists of a series of separate sequences where some of those sequences may have been recorded during separate sessions of the proceedings. The audio recording sequences are compressed 7 on site using a commerially available compressing program such as the one available from www.sourceforge.net. Both the compressed audio recording and the transcribed text are encrypted 8 before being securely transferred 9 via the Internet to the server 4 of the processing complex 1. The stripped audio portion, encrypted sequences and the transcribed text file are then erased 10 from the customer's station computer.

After receiving and storing the encrypted and compressed sequence and the text file, the server 4 distributes them 11 to any available workstation.

Upon receiving an encrypted compressed audio sequence and the encrypted text, a workstation decrypts them 12, and begins parsing the audio sequences. The process of parsing the sequences comprises using a speech-recognition program to generate textual renditions of the words in the recording sequences and looking for the corresponding words in the transcribed text file. More specifically, no word is recognized unless it is also found in the text file. The text file llimits the vocabulary available to the speech-recognition process. The time of occurrence for each matching, i.e. recognized word is recorded 13. Speech-recognition programs are available from a number of sources such as Microsoft accessible on the Internet at www.msdn.microsoft.com. The transcribed sequence and the recognized and timed words are then encrypted 14 and sent back 15 to the server 4. They are then erased 16 from the workstation's memory.

The server stores 17 the various recognized and timed words it has received from workstations, and distributes them in their encrypted form to available workstations 5.

When a workstation receives the sequences, it decrypts them 18, and begins to identify and delete 19 overlapping portions found on the head and tail segments of successive sequences as further explained below. The adjusted sequences are then combined 20 into a single file that is aligned 21 with the original transcribed text. That process envolves comparing the renditions to the words of the text file. Each time coincidence is found between a word output by the speech-recognition program, that word in the text file is marked 2 with a timing mark referenced to the beginning of the file. Words that are unintelligible or are not properly deciphered by the speech-recognition program are ignored. However, in the text file, words that are not matched with the output of the speech-recognition program are also time-marked by interpolation between the last and next identified ones. The aligned files are then encrypted and returned 22 to the server which stores them 23 and makes them available for download 24 by any customer stations. The timed words, transcript text and aligned file are erased 25 from the workstation's memory. The customer stations can then play the audio or audio-visual recording synchronized with the transcribed textual file which appears as a text line in the bottom of the display screen.

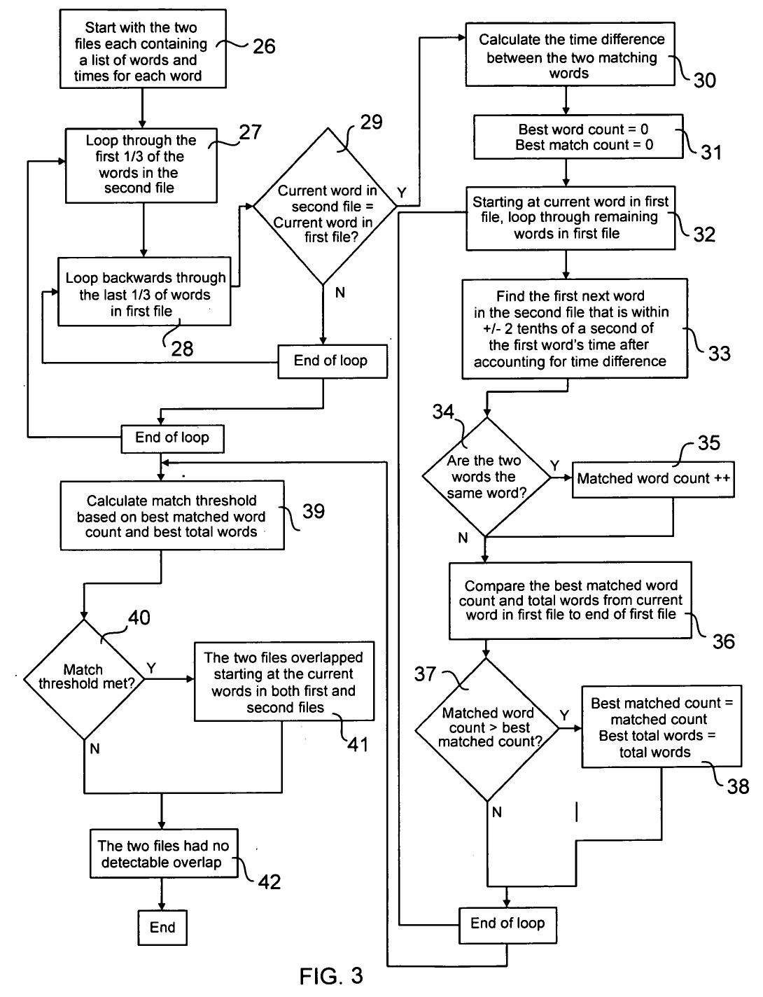

The process 19 of deleting the overlapping portion found on the head and tail segments of successive sequences is illustrated in FIG. 3. Starting 26 with two files containing lists of recognized and timed words, the program loops 27 through the first third of the words in the second file and loops backward 28 through last third of the words in the first file, and looks 29 for a match.

The time difference between the first matching words is calculated 30. A best word count and a best match count are set to zero.31. Starting with the current matching word in the first file, the program loops 32 through the remaining words in that file while looking 32 for the next word in the second file that falls within plus or minus 0.2 second of a word's time in the first file. The two words are compared 34. If they match, the matched word count is incremented 35. The best matched word count and total word count from the current word in first file to end of first file are compared 36. If the matched word count is greater 37 than the best matched count, the best match count is made equal 38 to the matched count, and a best total words count is equated to the total word count.

At the end of the looping process, the program calculates 39 a match threshold based on the best matched word and best total word counts. If the threshold is met 40, an overlap is declared 41 between the two files starting at the current word in both the first and second files. If the threshold is not met, the files are considered 42 to have no detectable overlap.

In the preferred embodiment of the invention, the match threshold is defined as any one of the following:
Best match count greater than 40, and best match count over best total word is greater than 0.5.
Best match count greater than 60 and best match count over best total words is greater than 0.4.
Best match count greater than 80, and best match count over best total words is greater than 0.3.

While the preferred embodiment of the invention has been described, modifications can be made and other embodiments may be devised without departing from the spirit of the invention and the scope of the appended claims.

1. A process for synchronizing an audio recording of proceedings and aligning it with a transcribed text file of said proceedings, said process comprising the steps of:
recognizing words in an audio file;
making a record of the times said words occur in said audio file;
matching said words with corresponding words in said text file;
marking the beginning each word in said text file with the time of occurrence, from said record, of the corresponding word in said audio file;
whereby any part of said audio and text files can be instantaneously found and displayed along with its corresponding part in the other one of said files.

2. The process of claim 1, wherein said recognizing comprises:
using speech-recognition program to generate textual renditions of words in said audio file; and
comparing said textual renditions with words in said text file.

3. The process of claim 2, wherein said recording comprises a series of separate sequences.

4. The process of claim 2, wherein said audio file is derived from a recording having an audio component and a video component; and
said step of creating further comprises separating the video component from said recording and using the audio component for creating said audio file.

5. The process of claim 4, wherein said audio file comprises a series of separate sequences.

6. The process of claim 5 which further comprises:
removing overlapping portions of said sequences; and
combining said sequences into a single continuous file.

7. The process of claim 6, wherein said audio file and said transcribed text file are provided by at least one customer's data processing station to a processing complex; and
said step of separating is performed by said station.

8. The process of claim 7 which further comprises compressing said audio file and said transcribed text file before transferring to said processing complex.

9. The process of claim 7, wherein said processing complex comprises a server and a plurality of work stations; and
said step of creating further comprises performing said matching and time-marking in at least one of said work stations.

10. The process of claim 6, wherein said step of removing overlapping portions comprises:
processing said sequences with a speech recognition program; and
comparing head and tail segments of said recording to identify and delete redundant parts.

11. The process of claim 9 which further comprises encrypting files before transfer between said customer station and said server and between said server and said workstations.

12. The process of claim 9, wherein said workstations are remotely located from said server; and
files are transferred between said customer stations, server and workstation via the Internet.

13. The process of claim 12, wherein said step of removing overlapping portions comprises said workstation returning said text and audio files to said server after said time-marking and said word matching; and
said server sending said files to at least one available one of said workstations to perform said removing.

14. The process of claim 2, wherein said recognizing further comprises limiting said renditions to words found in said text file.

15. The process of claim 3 which further comprises:
removing overlapping portions of said sequences; and
combining said sequences into a single continuous file.
